(19) United States
(12) Patent Application Publication
(10) Pub. No.: US 2013/0192446 A1
(43) Pub. Date: Aug. 1, 2013

(54) Multi Channel Digital Wind Instrument

(71) Applicants: Wayne Richard Read, Kittery, ME (US); Deidre Hebert, Dover, NH (US)

(72) Inventors: Wayne Richard Read, Kittery, ME (US); Deidre Hebert, Dover, NH (US)

(21) Appl. No.: 13/671,421

(22) Filed: Nov. 7, 2012

Related U.S. Application Data
(60) Provisional application No. 61/628,772, filed on Nov. 7, 2011.

(51) Int. Cl. G10H 1/02

(52) U.S. Cl. CPC G10H 1/02
USPC 84/609

(57) ABSTRACT

An electronic musical instrument whose operation is similar to a harmonica, and which can be played easily by anyone familiar with a harmonica. The instrument measures positive or negative pressure at the mouthpiece, with a MEMS (Micro-electro-mechanical system) pressure sensor, which produces an electronic signal, which is then converted to pre-sampled sounds of a variety of instruments via an on-board synthesizer, and is capable of sending MIDI (Musical Instrument Digital Interface) signals to control other electronic musical instruments or devices.

This invention relates to an electronic musical instrument capable of reproducing much of the feel of a harmonica, while providing the capacity to reproduce the sound of most any other instrument.

Prior art has considered the possibility of reproducing sound by means of measuring movement of reeds in a harmonica via optical or magnetic means. (James F. Antaki, U.S. Pat. No. 6,326,532). Other instruments (James Wheaton, U.S. Pat. No. 5,245,130: Ron Schille, U.S. Pat. No. 4,984,499) have utilized flow sensors, requiring a mechanism within the air stream. The current invention requires no reeds, there is no air flow through the sensor, and there are no moving parts in the air stream.

The mouthpiece, containing multiple holes, channels air to pressure sensors which then translate that pressure to electrical voltages. To provide a simulation of the air flow through the mouthpiece (bleed), similar to a harmonica, holes are provided which can be tailored to the player's individual needs. The mouthpiece is removable and replaceable allowing for different hole spacing, shapes and bleed. Unlike mouth-pieces designed for separate passages for blow and draw (Yasuo Nagura, U.S. Pat. No. 4,252,045), the use of an ambient-referenced pressure sensor eliminates the need for separate passages and sensors, making the mouth-piece that is simple in design.

Behind the mouthpiece is a mating component which provides a seal to the mouthpiece, and an interface to the pressure sensors. The sensors, referenced in above, are ambient-referenced, and convert the pressure from each hole into a DC voltage, which is read by a digital to analog converter.

Pressure-transducers have been considered in the past (John J. Criglar et al, U.S. Pat. No. 4,119,007) as components in a wind instrument, to measure vibrations within the air column. The device described in this patent is not being used to measure and reproduce a vibration, but to trigger and control the dynamics of a synthesized sound.

Utilizing programmable System on Chip technology, analog to digital conversion, as well as menu system, memory, USB I/O and MIDI I/O are implemented on a single chip. Within this chip, analog signals from the pressure sensors are converted to a digital signal. A processor reads the signals from the pressure sensors and, depending on the configuration of the instrument, plays on-board sounds, sends MIDI signals to an external synthesizer, or both.

The instrument is configured by means of a user interface which allows it to play percussive or non-percussive sounds with equal facility. In the percussive mode, each instrument is played at a pre-determined volume of attack. In the non-percussive mode, the instrument plays each note based on the instantaneous air pressure at the mouth-piece. A third mode is a blend of each of these, with a pre-set trigger level for the note.

All notes are independent of each other; this results in the ability to play one note loudly, and one note softly—with a skilled player able to vary the amount of air being sent to adjacent holes. As well as independent volume information, each hole may be assigned an individual instrument. This would permit, for example, a player to play a bass on one side of the instrument, while using the other side to play a flute, strings, or other lead instrument.

To simulate the operation of a chromatic harmonica, a joy-stick is provided. Depending on the user's configuration of the instrument, the joystick can be used to shift notes up, down, or both. Unlike a typical chromatic harmonica, this feature permits a total of 66 notes in an eleven-hole instrument.

The joystick may be configured to offer other features as well, such as pitch-bend, program changes, insertion of effects, key changes and any other feature added to the harmonica. The user interface may consist of either an LCD screen and a rotary encoder for user input, or a touch-screen display.

On-board memory permits the user to save complete instrument set-up data, which may be recalled during performances, and accessed in real time by the joystick. When the instrument is configured as a sequencer, performance data may be recorded for future playback.

Prior attempts at creating an electronic harmonica have resulted in a device requiring external sound synthesis via wire or radio emissions. This instrument places sound synthesis within the body of the instrument. A headphone jack, as well as a line-out jack permit the instrument to be used in privacy, or to be connected to an amplification system.

A USB port is part of the instrument which permits charging of internal batteries, and uploading or downloading settings, program information, or to upgrade the resident firmware as new features are developed.

### DESCRIPTION OF ILLUSTRATIONS

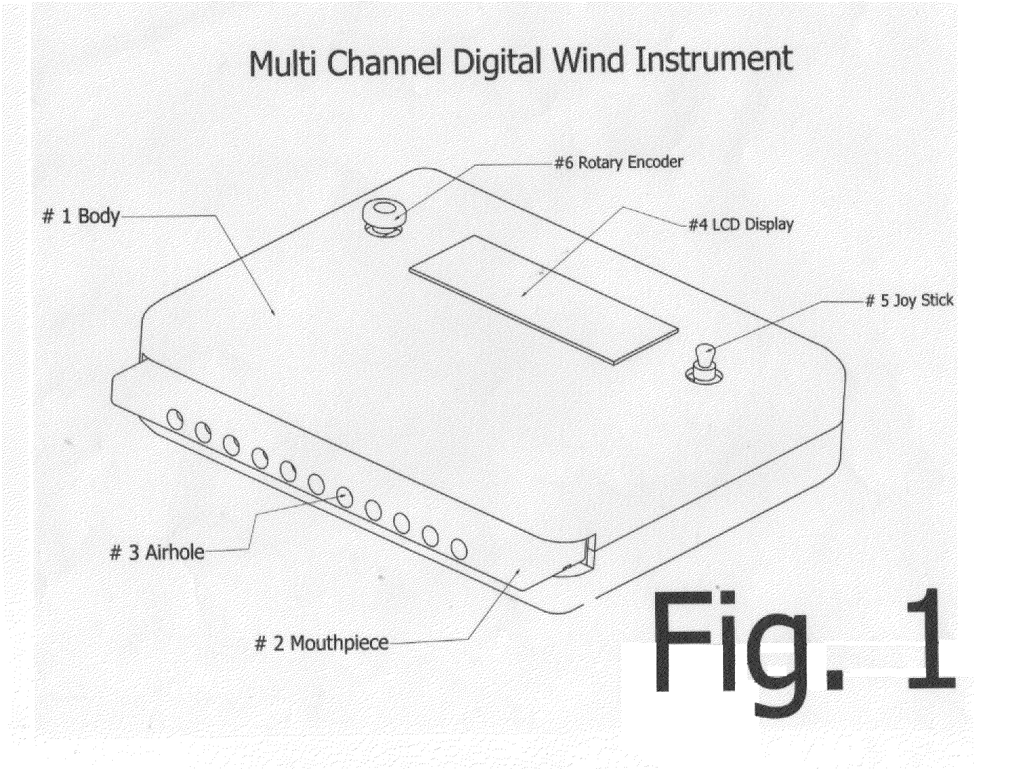

FIG. 1. Exterior view of the enclosure which houses the electronics, air pressure sensors, and power supply for the device.

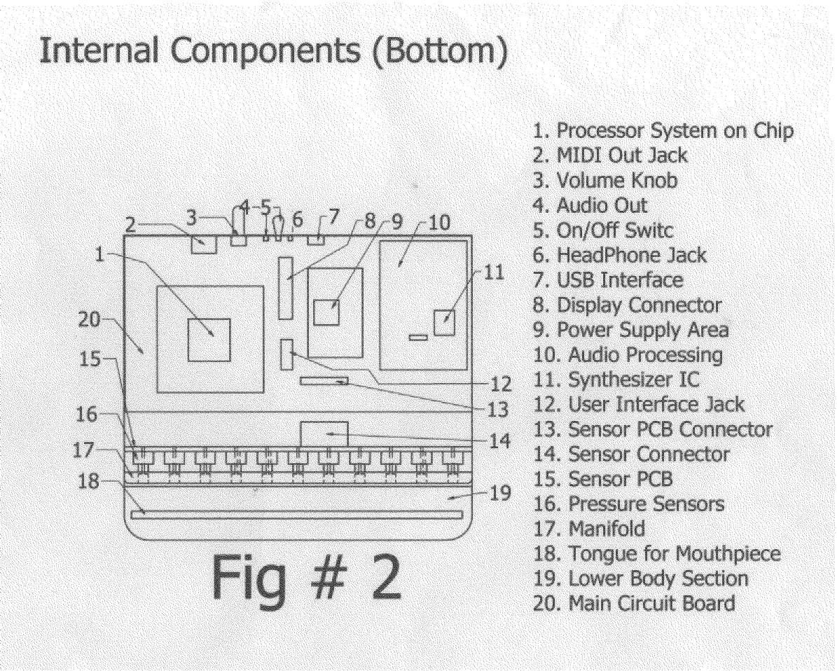

FIG. 2. Interior view which houses electronics

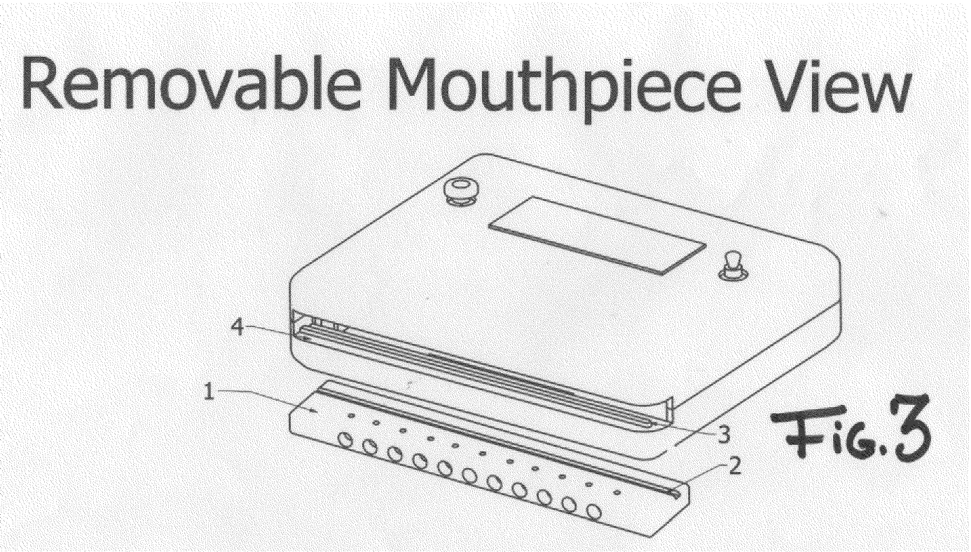

FIG. 3. Mouthpiece (enhanced view) currently showing a removable eleven holed mouthpiece

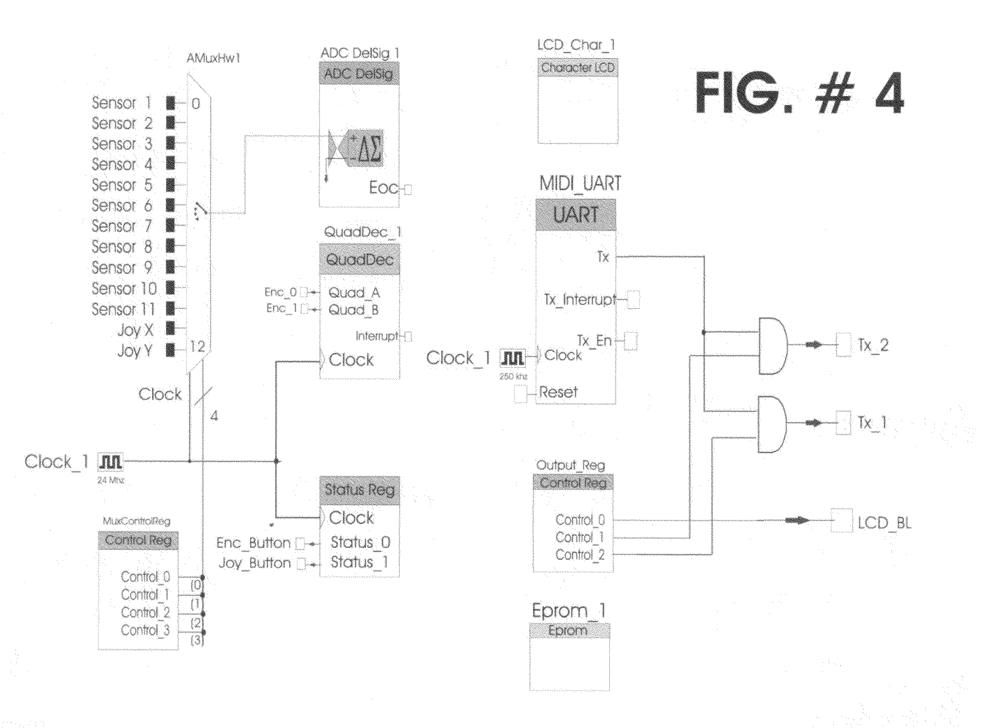

FIG. 4. A block diagram of the analog/digital Programmable System On a Chip.

### DETAILED DESCRIPTION OF FIG. 1

FIG. 1 #1 Body: Approx. 6″×6″×1″ two piece (top and bottom) enclosure with rounded filleted edges and corners. Body (top) has holes cut out for (# 4 LCD display) and (#5 and # 6 navigation and selector knobs). Body has front end open with slot and tongue to allow insertion of removable and interchangeable (#2. Mouthpiece) with matching groove. Preferred material is ABS plastic, brushed aluminum or exotic wood.

FIG. 1 #2 Mouthpiece: has eleven holes or chambers but other models could have ten holes and as many as twenty holes that may vary in size and shape according to a players needs. It is removable and replaceable so the instrument could be played by more than one player without the fear of germ transmission. There are eleven small air holes on the bottom of the mouthpiece located under each chamber to allow for inhaled and exhaled air flow adding more comfort and playability. Preferred material is ABS plastic, Delmar, or exotic woods. Approximate size is 6″×1″×⅜″

FIG. 1 #3 Air holes. Round, square or hexagon shaped, approximately ¼″ in diameter and 1″ in length. Holes are evenly spaced and can be designed further apart or closer together depending on desired results. Closer holes may be used for chords and further spaced holes used for soloing.

FIG. 1 # 4 LCD Display is backlit and used to display menu choices such as scale, key, instrument and so forth.

FIG. 1 # 5 Joystick is used mostly in live performance mode to quickly change from pre-saved menu choices and also used as a pitch bend up or down allowing full chromatic scales. The joystick may be further used to add effects such as tremolo, vibrato, or distortion.

FIG. 1 # 6 Rotary Encoder designed to access menu, scroll through menu items and add titles to favorite patches stored in various banks on chip.

### Detailed Description of FIG. 2

FIG. 2 #1 Processor System on Chip

FIG. 2 #2 MIDI out jack for connecting to other MIDI instruments

FIG. 2 #3 Volume knob potentiometer used for adding or lowering volume.

FIG. 2 #4 Audio out jack for connecting to an outboard amplifier or PA system.

FIG. 2 #5 Power Switch for turning instrument on and off

FIG. 2 #6 Headphone Jack for connecting headphones.

FIG. 2 #7 USB Jack interface for connecting to computer for updates and program changes

FIG. 2 #8 Display Connector connects LCD display via ribbon cable

FIG. 2 #9 Power supply area contains voltage regulator and battery.

FIG. 2 #10 Audio processing area

FIG. 2 #11 On board synthesizer for internal sounds.

FIG. 2 #12 User interface jack as an optional way to communicate with computer.

FIG. 2 #13 Sensor PCB connector for ribbon cable to connect to sensor board

FIG. 2 #14 Sensor Connector connects sensor board to main PC board

FIG. 2 #15 Sensor PC board housing air pressure sensors and caps and filters

FIG. 2 #16 Pressure Sensors used to detect change in air pressure which determines how loud or soft a note or sound will be played

FIG. 2 # 17 Sensor Manifold aligns and holds sensor nipple for exact match up with removable mouthpiece.

FIG. 2 #18 Tongue which accepts the groove on bottom of replaceable mouthpiece and assures sealed alignment with mouthpiece

FIG. 2 #19 Lower half of body enclosure.

FIG. 2 #20 Main Circuit Board. Houses and interconnects all component and power supply.

### Detailed Description of Mouthpiece FIG. 3

FIG. 3 #1 Mouthpiece shown bottom-side up to reveal slot for mating to enclosure. Mouthpiece with eleven holes evenly spaced. Number of holes could vary when additional notes or sounds are needed. Shapes of holes may be round, square oval, or hexagon shaped. Preferred material is ABS plastic but works well with exotic woods and other plastics. As shown in drawing mouthpiece is totally removable and can be replaced with different configurations of spacing and shapes of shafts.

FIG. 3 #2 Slot running the length of mouthpiece designed to mate with tongue in FIG. 3 #3.

FIG. 3 #3 Tongue which is part of lower half of enclosure FIG. 2. Designed to mate with groove or slot in mouthpiece FIG. 3 #2

FIG. 3 #4 Channel cut into upper and lower enclosure FIG. 1. Channel designed to accept removable mouth piece FIG. 3 # 1

### Detailed Description of FIG. 4

Input signals from individual sensors and the Joystick multiplexed and converted to digital via the Delta Sigma Analog to Digital converter. A control register is used to address the multiplexer, selecting the desired input signal. In those systems where the input device is a rotary encoder, a quadrature decoder is utilized to determine the user activity at that device. Inputs from the pushbuttons are read via a status register. The Character LCD segment controls the LCD display. A similar segment of hardware will control a color LCD touch-screen display in those models. EEPROM is utilized to save user settings.

The combination of the UART and a second control register are utilized to send MIDI information, selectively, to either the internal or an external synthesizer.

What is claimed is:

1: A musical instrument consisting of a mouth-piece similar in appearance to a harmonica, with each passage corresponding to two different notes to be determined by a computer program running on an embedded processor in the instrument. The instrument comprises the mouth-piece, MEMS (Micro-electro-mechanical system) pressure sensors, a means to measure the output of said sensors, a user interface to control the instrument, a microprocessor, the firmware or software program, a sound-synthesis system, as well as a battery, charging system and various interface components.

2: A means to measure breath pressure above and below ambient air pressure in an instrument similar to a harmonica, enabling multiple notes to be played by inhaling and exhaling through ports in the mouth-piece.

3: A method of utilizing air pressure in an electronic wind instrument to control audio musical effects via variations in air pressure.

4: The apparatus of claim 1 further including a method to configure said apparatus, permitting it to assign various notes to individual ports and pressures within said ports, instruments assigned to said ports, and any effects to be applied to the notes played on said ports.

5: The apparatus of claim 1 further including a user interface comprising liquid crystal or other display device, a joystick to enable real-time changes in the instrument operation such as pitch-bend, note shifting, effects, MIDI instrument patch changes, key changes and other instrument parameters.

6: The apparatus of claim 1 further including a removable mouth-piece consisting of a plurality of air passages designed to direct air pressure to the various pressure sensors in the body of the instrument.

7: The apparatus of claim 6 wherein individual mouth-pieces may be constructed with varying spacing between adjacent holes, and with differently shaped holes, according to player preference.

8: The apparatus of claim 6 wherein vent holes of various dimensions may be chosen to facilitate optimal breath-control while playing the instrument.

9: The apparatus of claim 1 further including a drip tray beneath vent holes in the mouth-piece contains a drip-tray to retain moisture escaping from the vent holes in the mouth-piece.

10: The apparatus in claim 1 wherein a guard-band in the center of the pressure transducer's range is used to prevent notes from being accidentally played, and wherein this guard-band may be increased or decreased to facilitate—e.g. playing out of doors or in a windy location.

11: The apparatus in claim 1 wherein define pressures at the top and bottom of the instrument's sensing range are used to trigger various effects, such as vibrato or pitch-bending, such that by blowing or drawing with increasing force, past the maximum volume of the instrument, these effects may be achieved by the player.
